(19) United States
(12) Patent Application Publication
(10) Pub. No.: US 2004/0066606 A1
(43) Pub. Date: Apr. 8, 2004

(54) Electricity accumulating element

(75) Inventors: Masashi Ohata, Neyagawa-city (JP); Hiroshi Tsushima, Takatsuki-city (JP); Takeshi Oka, Kobe-city (JP)

Correspondence Address: Law Offices of Townsend & Banta, Suite 900, South Building, 601 Pennsylvania Ave., N.W., Washington, DC, 20004, US

(73) Assignee: Nippon Paint Co., Ltd.

(21) Appl. No.: 10/673,373

(22) Filed: Sep. 30, 2003

(30) Foreign Application Priority Data
Oct. 2, 2002 (JP) 2002-290300

(51) Int. Cl. H01G 4/06

(52) U.S. Cl. 361/524

(57) ABSTRACT

An electricity accumulating element comprising a pair of electrodes, and a dielectric thin film and a solid electrolyte thin film sandwiched between the electrodes, wherein the dielectric thin film is a metal oxide thin film such as a chromium oxide thin film. The metal oxide thin film preferably has a thickness of 1 to 100 nm, and is preferably a film obtained by subjecting to heat treatment at a temperature of 400 to 800° C. The solid electrolyte thin film is preferably a thin film obtained by firing a silicon-containing compound at a temperature of 200° C. or more.

### BACKGROUND OF THE INVENTION

1. Field of the Invention

The present invention relates to an electricity accumulating element having a dielectric thin film and a solid electrolyte thin film between a pair of electrodes.

2. Description of Related Art

It is reported that electroconductivity is exhibited by causing a highly electron-accepting compound such as molecular iodine or antimony fluoride to act on a silicon compound having a Si—Si bond as a main structure, such as polysilane (for example, Synthetic Metal, vol. 94, p. 299 (1998)).

As a method for making the whole of an electricity accumulating element into a solid form, there is known a method of using, as an electrolyte, a polymer material wherein an alkali metal salt such as lithium sulfate or lithium perchlorate is dispersed in a polar polymer such as polyethylene oxide, the polymer material being called solid electrolyte.

However, polysilane electroconductive materials wherein a highly electron-accepting compound such as molecular iodine or antimony fluoride is caused to act are instable and are difficult to handle in the air. It is therefore impossible to apply the materials to industrially useful electronic devices, typical examples of which include an energy element, a sensor and a transistor.

In the case of polymer solid electrolytes, the ion conductivity thereof is smaller than that of liquid or gel-form electrolytes; therefore, batteries using the polymer solid electrolytes do not satisfy specification for practical batteries.

### SUMMARY OF THE INVENTION

An object of the present invention is to provide an electricity accumulating element having a large electrostatic capacity.

The present invention is an electricity accumulating element comprising a pair of electrodes, and a dielectric thin film and a solid electrolyte thin film sandwiched between the electrodes, wherein the dielectric thin film is a metal oxide thin film. The metal oxide thin film is preferably a chromium oxide thin film. The chromium oxide thin film is preferably a film obtained by subjecting a chromium nitrogen oxide thin film to heat treatment at a temperature of 400 to 800° C.

Examples of other metal oxide thin films include thin films made of oxides of lithium, calcium, magnesium, aluminum, zinc, yttrium, iridium, indium, cadmium, gadolinium, gallium, gold, silver, silicon, germanium, cobalt, samarium, zirconium, tin, strontium, cesium, cerium, selenium, tungsten, carbon, tantalum, titanium, iron, tellurium, copper, lead, niobium, nickel, platinum, vanadium, palladium, manganese, bismuth, and molybdenum. Oxides of alloy composed of two or more out of these metals may be used.

The thickness of the metal oxide thin film is preferably from 1 to 100 nm.

If the thickness of the metal oxide thin film is less than 1 nm, electricity may conduct through the thin film. If the thickness is more than 100 nm, the electrostatic capacity may become too small.

According to the present invention, an electricity accumulating element having a large electrostatic capacity can be produced by setting the metal oxide thin film between a pair of electrodes.

In the present invention, a solid electrolyte thin film is further set between the pair of electrodes. The solid electrolyte thin film in the present invention may be a thin film obtained by firing a silicon-containing compound at a temperature of 200° C. or more. The firing temperature of the silicon-containing compound is more preferably from 300 to 1500° C.

An example of the silicon-containing compound may be a compound comprising at least one selected from a polysilane which is soluble in organic solvent and a silicone compound. A preferable example of the silicon-containing compound is a compound comprising both of the polysilane and the silicone compound.

The following will describe the polysilane and the silicone compound.

<Polysilane>

The polysilane used in the present invention is any polysilane that is a linear, cyclic or branched silane compound having a Si—Si bond. The category of the polysilane includes compounds which are called polysilines.

Polysilane referred to herein is at least one polymer selected from the group consisting of linear polysilanes and cyclic polysilanes each having, in the chemical structure thereof, a main skeleton structure represented by the following general formula:

(R¹₂Si)ₘ (1)

wherein R¹'s, which may be the same or different, are each a hydrogen atom, or an alkyl, alkenyl, arylalkyl, aryl, alkoxy, hydroxyl, hydroxyl-containing phenyl, amino or silyl group, and m is from 2 to 10000,

silicone network polymers each having, in the chemical structure thereof, a main skeleton structure represented by the following general formula:

(R²Si)ₙ (2)

wherein R²'s, which may be the same or different, are each a hydrogen atom, or an alkyl, alkenyl, arylalkyl, aryl, alkoxy, hydroxyl, hydroxyl-containing phenyl, amino or silyl group, and n is from 4 to 10000, and

silicone network polymers each having, in the chemical structure thereof, a main skeleton structure represented by the following general formula:

(R³₂Si)ₓ(R³Si)_{y}Si_{z} (3)

wherein R³'s, which may be the same or different, are each a hydrogen atom, or an alkyl, alkenyl, arylalkyl, aryl, alkoxy, hydroxyl, hydroxyl-containing phenyl, amino or silyl group, and the sum of x, y and z is from 5 to 10000.

In the polysilanes represented by the general formulae (1), (2) and (3), examples of the alkyl moiety of the alkyl group or the arylalkyl group and the alkyl moiety of the alkoxy group include linear, cyclic and branched aliphatic hydrocarbon groups having 1 to 14 carbon atoms, preferably 1 to 10, and more preferably 1 to 6. Examples of the alkenyl group include monovalent linear, cyclic and branched aliphatic hydrocarbon groups having at least one carbon-carbon double bond and having 1 to 14 carbon atoms, preferably 1 to 10 and more preferably 1 to 6 carbon atoms. Examples of the aryl moiety of the aryl group and the arylalkyl group include aromatic hydrocarbon groups which may have at least one substituent. Preferred is a phenyl or naphthyl group which may have at least one substituent. The kind of the substituent of the aryl moiety of the aryl group or the arylalkyl group is not particularly limited. The substituent is preferably at least one selected from the group consisting of alkyl, alkoxy, hydroxide, and amino groups.

The polysilane used in the present invention may have at least one hydroxyl group bonded directly to one ore more Si atoms therein (i.e., a silanol group). The polysilane used in the present invention may have, on average per molecule thereof, one or more hydroxyl groups bonded directly to one or more Si atoms therein. The number of the hydroxyl groups contained in the polysilane is usually from about 0.01 to 3, preferably about 0.1 to 2.5, more preferably about 0.2 to 2 and most preferably about 0.3 to 1.5 on average per Si atom.

The method for introducing the hydroxyl groups to the polysilane may be any known method. For example, in a method of subjecting a halosilane to dehalogenation polycondensation or some other method, the introduction can easily be conducted by adding water to the reaction system at the time of the end of the polycondensation reaction.

There can also be used a silicon based polymer, containing a Si—Si bond, obtained by subjecting the above-mentioned polysilane to heat treatment at 300° C or more in the atmosphere of an inert gas such as nitrogen or argon, or in the air.

As the polysilane, a silicon network polymer having a network structure is preferably used.

As the polysiline, a network-form polysilane described in Japanese Patent Application Laid-Open (JP-A) No. 2001-48987 can be used. That is, there can be used a network-form polysilane produced by causing Mg or Mg alloy to act on trihalosilane in an aprotonic solvent in the presence of a Li slat or a metal halide.

As the polysilane used in the present invention, a polysilane having a weight-average molecular weight of 1000 or more is preferred. If the weight-average molecular weight is less than 1000, properties of the resultant film, such as chemical resistance and heat resistance, may be insufficient. The weight-average molecular weight is more preferably from 1000 to 20000, still more preferably from 1000 to 10000.

<Silicone Compound>

An example of the silicone compound used in the present invention is a compound represented by the following general formula:

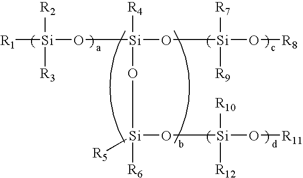

wherein R₁ to R₁₂, which may be the same or different, are each a group selected from the group consisting of an aliphatic hydrocarbon which has 1 to 10 carbon atoms and may be substituted with a halogen or a glycidyloxy group, an aromatic hydrocarbon group having 6 to 12 carbon atoms, and an alkoxy group having 1 to 8 carbon atoms; a, b, c and d are each an integer of 0 or more; and a+b+c+d≧1.

Specific examples of the aliphatic hydrocarbon group which this silicone compound has include chain-form groups such as methyl, propyl, butyl, hexyl, octyl, decyl, trifluoropropyl, glycidyloxypropyl groups; and alicyclic groups such as cyclohexyl and methylcyclohexyl groups. Specific examples of the aromatic hydrocarbon group include phenyl, p-tolyl, and biphenyl groups. Specific examples of the alkoxy group include methoxy, ethoxy, phenoxy, octyloxy and tert-butoxy groups.

The kind of R₁ to R₁₂ and the values of a, b, c and d, which are not particularly important, are not particularly limited if the silicone compound is made compatible with the polysilane and organic solvent and the resultant film is made transparent. In the case of considering the compatibility, it is preferable that the silicone compound has the same hydrocarbon group as the used polysilane has. In the case of using a phenyl methyl type polysilane as the polysilane, it is preferable to use, for example, a silicone compound of the same phenyl methyl type or a biphenyl type. It is possible to use, as a crosslinking compound, a silicone compound having in a single molecule thereof two or more alkoxy groups, such as a silicone compound wherein at least two selected from R₁ to R₁₂ are alkoxy groups having 1 to 8 carbon atoms. Examples of such a silicone compound include methyl phenyl methoxysilicone and phenyl methoxysilicone containing 15 to 35% by weight of alkoxy groups.

The silicon-containing compound may further comprise a silicon compound and at least one selected from a peroxide and a benzphenone derivative having a benzophenone skeleton.

The solid electrolyte thin film in the present invention is not limited to the above, and other examples thereof include a thin film made of manganese dioxide, and a thin film made of an electroconductive polymer (such as polypyrrole).

The thickness of the solid electrolyte thin film in the present invention is not particularly limited. The thickness is preferably from 1 to 100000 nm.

Examples of the metal which can be used in the electrodes in the present invention include lithium, calcium, magnesium, aluminum, zinc, yttrium, iridium, indium, cadmium, gadolinium, gallium, gold, silver, chromium, silicon, germanium, cobalt, samarium, zirconium, tin, strontium, cesium, cerium, selenium, tungsten, carbon, tantalum, titanium, iron, tellurium, copper, lead, niobium, nickel, platinum, vanadium, palladium, manganese, bismuth, and molybdenum. Oxides of alloy composed of two or more out of these metals may be used. For the metal oxide thin film, oxides of the above-mentioned metals or alloys thereof can be used.

Examples of the electroconductive compound which can be used in the electrodes include electroconductive polymers such as polyacetylene, polythiophene, polyparaphenylene vinylene, polypyrrole, polyparaphenylene, polyacene, polythiazyl, polyparaphenylene sulfide, poly(2,5-thienylenevinylene) and polyfluorene; derivatives thereof; and aromatic amine derivatives and polymers thereof. These electroconductive organic compounds may be used alone or in a state that a doping agent such as iodine is incorporated thereto.

The electricity accumulating element of the present invention can be charged by applying a given voltage or electric current between the pair of electrodes. After the charging, this element can be used as a power supply by taking off the used battery charger and then making the element and a load up to a closed circuit.

### DESCRIPTION OF PREFERRED EXAMPLES

The present invention will be described in detail by way of the following examples hereinafter, but the present invention is not limited to these examples.

### Example 1

An electroconductive chromium compound thin film substrate, wherein a chromium nitrogen oxide thin film (thickness: 20 nm) and a chromium thin film (thickness: 15 nm) were alternately and repeatedly deposited so as to form a five-layer structure having one of the chromium nitrogen oxide thin films as the topmost layer, was subjected to heat treatment at 500° C. for 2 hours, so as to yield a heat-treated substrate. The composition of this heat-treated substrate in the depth direction from the topmost surface was analyzed by X-ray photoelectron spectroscopy. As a result, it was verified that a thin film made of a chromium oxide (Cr:O=about 1:1) and having a thickness of about 20 nm was present in the topmost surface. The topmost surface portion was made of an insulator having a resistance of 1 MΩ or more.

Next, the following was applied onto this heat-treated substrate: a silicon compound solution wherein 2 parts by weight of polymethylphenylsilane, 1 part by weight of polyalkylphenylsiloxane (silicone TSR-165, manufactured by GE Toshiba Silicone Co.), 0.3 part by weight of 3,3′,4,4′-tetra-(t-butylperoxycarbonyl)benzophenone (BTTB-25, manufactured by NOF Corp.) and about 1/100 part by weight of a surfactant (R-08, manufactured by Dainippon Ink & Chemicals, Inc.) were dissolved in anisole at a dark place. The applied solution was then dried. Thereafter, the resultant was fired at 550° C. for 30 minutes to produce a solid electrolyte thin film.

Next, aluminum was vacuum-evaporated onto this solid electrolyte thin film so as to produce a sandwich type test cell (apparent electrode area: 0.15 cm²) having a structure of aluminum/the silicon compound thin film (solid electrolyte thin film) /the chromium oxide (dielectric thin film)/the electroconductive chromium compound.

About the test cell obtained through the above-mentioned process, the electrostatic capacity thereof at 100 Hz was measured with an LCR meter. As a result, the electrostatic capacity was 0.23 μF. The electrostatic capacity per unit area is shown in Table 1.

### Example 2

A sandwich type test cell was produced in the same way as in Example 1 except that a manganese dioxide thin film was formed instead of the silicon compound thin film as the solid electrolyte thin film. The manganese dioxide thin film can be formed by a known method.

About the test cell obtained through the above-mentioned process, the electrostatic capacity thereof at 100 Hz was measured with an LCR meter. As a result, the electrostatic capacity was 0.23 μF. The electrostatic capacity per unit area is shown in Table 1.

TABLE 1

| | Electrostatic capacity (μF) |
|---|---|
| | per unit area |
| Example 1 | 1.5 |
| Example 2 | 1.5 |
| Comparative | 0.1 |
| Example | |

### Comparative Example

A sandwich type test cell was produced in the same way as in Example 1 except that the electroconductive chromium compound thin film substrate was used, as it was, without being heat-treated.

About the test cell obtained through the above-mentioned process, the electrostatic capacity thereof at 100 Hz was measured with an LCR meter. As a result, the electrostatic capacity was 0.05 μF. The electrostatic capacity per unit area is shown in Table 1.

As is evident from Table 1, it can be understood that the test cells of Examples 1 and 2 according to present invention had a far higher electrostatic capacity than the test cell of Comparative Example.

According to the present invention, an electricity accumulating element having a large electrostatic capacity can be produced. The electricity accumulating element of the present invention can widely be used as an element of various electronic devices, and has a very high industrial value.

What is claimed is:

1. An electricity accumulating element comprising a pair of electrodes, and a dielectric thin film and a solid electrolyte thin film sandwiched between the electrodes,
wherein the dielectric thin film is a metal oxide thin film.

2. The electricity accumulating element according to claim 1, wherein the thickness of the metal oxide thin film is from 1 to 100 nm.

3. The electricity accumulating element according to claim 1, wherein the metal oxide thin film is a chromium oxide thin film.

4. The electricity accumulating element according to claim 3, wherein the chromium oxide thin film is a film obtained by subjecting a chromium nitrogen oxide thin film to heat treatment at a temperature of 400 to 800° C.

5. The electricity accumulating element according to claim 1, wherein the solid electrolyte thin film is a thin film obtained by firing a silicon-containing compound at a temperature of 200° C. or more.

6. The electricity accumulating element according to claim 5, wherein the silicon-containing compound comprises at least one selected from a polysilane which is soluble in organic solvent and a silicone compound having a chemical structure represented by the general formula: 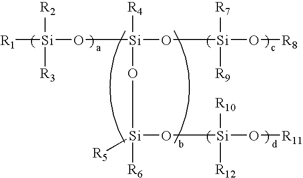
wherein R₁ to R₁₂, which may be the same or different, are each a group selected from the group consisting of an aliphatic hydrocarbon which has 1 to 10 carbon atoms and may be substituted with a halogen or a glycidyloxy group, an aromatic hydrocarbon group having 6 to 12 carbon atoms, and an alkoxy group having 1 to 8 carbon atoms; a, b, c and d are each an integer of 0 or more; and a+b+c+d≧1.

7. The electricity accumulating element according to claim 6, wherein the silicon-containing compound further comprises a silicon compound and at least one selected from a peroxide and a benzphenone derivative having a benzophenone structure.
